(19) United States
(12) Patent Application Publication
(10) Pub. No.: US 2004/0134744 A1
(43) Pub. Date: Jul. 15, 2004

(54) Apparatus for classifying banknotes

(76) Inventor: Christian Voser, Satigny (CH)

Correspondence Address: FISH & RICHARDSON P.C., 45 ROCKEFELLER PLAZA, SUITE 2800, NEW YORK, NY, 10111, US

(21) Appl. No.: 10/734,904

(22) Filed: Dec. 12, 2003

(30) Foreign Application Priority Data
Dec. 13, 2002 (EP) 02258599.6

(51) Int. Cl. G06K 7/00; G07D 7/00; G07F 7/04; G06K 9/00

(52) U.S. Cl. 194/207

(57) ABSTRACT

Banknotes are classified by determining their spectral characteristics in respective areas using diffusely-reflected light from the banknote and/or light transmitted through the banknote. In addition, the surface condition of the banknote is detected by using specularly-reflected light. Preferably, the same transmitter is used to generate the light which is diffusely-reflected and specularly-reflected.

### BACKGROUND

This invention relates to an apparatus for classifying banknotes by sensing their optical characteristics.

Such apparatus is commonly used to determine the authenticity and denomination of banknotes. Often, a banknote is moved along a path past optical transmitters and receivers so that the transmission or reflection characteristics in respective areas of the banknote can be determined by scanning. The apparatus may include transmitters which operate in multiple wavelengths, such as red, green, blue and infra-red. (It is noted that the terms “optical”, “colour” and “light” are used herein to refer to any electromagnetic wavelength, and not merely visible wavelengths.)

Prior art arrangements are generally designed so that sensors responsive to reflected light receive light which is diffusely reflected by the banknote, because this provides a much more representative measurement of the optical characteristics of the banknote than directly (specularly) reflected light. Spectral measurements based on specularly reflected light can easily be overwhelmed depending on the surface condition of the banknote (e.g. its shininess).

It would be desirable to provide an improved apparatus for detecting the optical characteristics of banknotes.

### SUMMARY

Aspects of the present invention are set out in the accompanying claims.

In accordance with a further aspect of the invention, a validator is responsive to light which is diffusely reflected from, and/or transmitted through, a banknote and also light specularly reflected from the banknote. Preferably, the apparatus is arranged to take respective measurements of the same banknote areas using specularly-reflected light as well as diffusely-reflected and/or transmitted light. A common transmitter could be used for generating the light used in both, or all three, measurements.

It has been found that valuable information can be obtained by measuring direct (i.e. specular) reflection in addition to diffuse reflection and/or transmissivity. By additionally measuring directly-reflected light, it is possible to sense not just the colours in individual areas, but also the state of the surface of the banknote. The further information obtained in this manner can be used in the authentication of the banknote, or to test the fitness of the banknote, e.g. to determine whether it should be dispensed.

Amongst the features which can be detected using specularly-reflected light are, for example, the glossiness of the banknote, or shiny areas caused by metal strips incorporated into the banknote or by adhesive tape on the banknote. Additionally, or alternatively, the paper quality or texture could be sensed. The directly-reflected light could also, or alternatively, be used (possibly in combination with a diffuse-reflection measurement) to distinguish between intaglio-printed ink and ink of uniform thickness. The provision of sensors for detecting reflected light at different angles (i.e. a diffuse-reflectivity sensor and a direct-reflectivity sensor) could also be useful in detecting optically-variable ink.

Preferred arrangements according to the present invention have a geometrical structure which relies upon light paths for transmissive and diffuse-reflective measurements which avoid the path taken by direct light reflection. Accordingly, it is particularly simple to provide such structures with means for additionally detecting directly-reflected light.

In accordance with another aspect of the invention, a light transmitter and at least two light receivers are arranged on the same side of the path of a banknote, one receiver being arranged to receive light diffusely reflected by the banknote and travelling in a direction which is substantially opposite to that of the light transmitted by the transmitter and the other receiver being arranged to receive light which is directly reflected by the banknote. By arranging for the light paths to be inclined with respect to the normal to the banknote and for the light incident on the banknote to be collimated so that it does not diverge when considered in at least one plane containing the normal to the banknote, it is possible for the first receiver to avoid receiving directly-reflected light.

Preferably, the banknote is moved in a scanning direction relative to the incident light, and the light is collimated so that it does not diverge when considered in a plane containing both the scanning direction and the normal to the plane of the banknote. Preferably, the incident light is arranged to diverge when viewed in a plane which contains the normal to the banknote and which is transverse to the scanning direction, so that a single transmitter can be used to illuminate a relatively wide area of the banknote as the banknote is moved in the scanning direction past the transmitter. Preferably, each transmitter is associated with at least two diffuse-reflection receivers, which could be mounted on opposite sides of the transmitter (displaced in a direction transverse to both the scanning direction and the direction normal to the plane of the banknote) for receiving light from respective areas of the banknote.

### BRIEF DESCRIPTION OF DRAWINGS

An arrangement embodying the invention will now be described by way of example with reference to the accompanying drawings, in which:

FIG. 1 is a schematic diagram to illustrate some of the principles of operation of an apparatus according to the invention;

FIG. 2 is a schematic side view showing the operation of devices of the apparatus for measuring transmittance and reflectance characteristics of a banknote;

FIG. 3 is a schematic end view of the device of FIG. 2;

FIG. 4 is a diagram of a banknote validator in accordance with the invention;

FIG. 5 is a side view of an apparatus for measuring transmittance and reflectance characteristics of a banknote, the apparatus forming part of the validator of FIG. 4;

FIG. 6 is a perspective view illustrating an optical module of the apparatus of FIG. 5; and

FIG. 7 is a plan view illustrating regions of a banknote which are scanned by the apparatus of FIG. 5.

### DETAILED DESCRIPTION

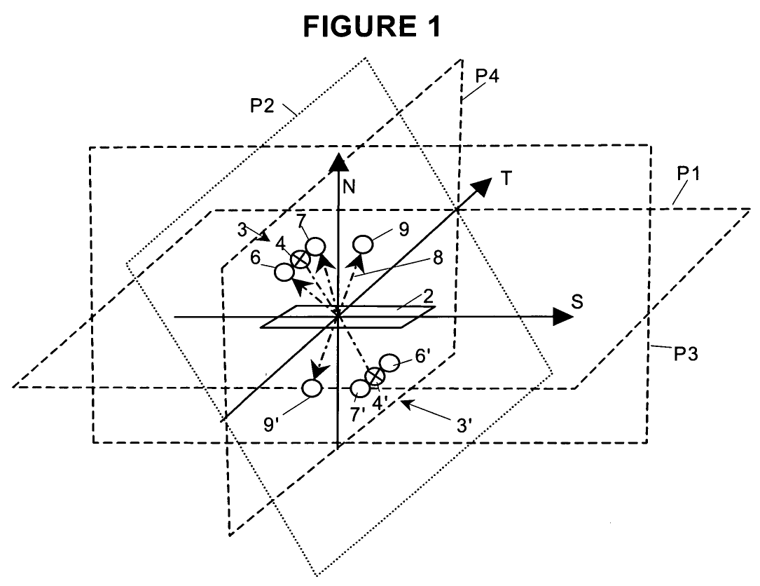

Referring to FIG. 1, a banknote 2 lies in a plane P1. In an embodiment of the present invention, drive means are provided for conveying the banknote 2 in a scanning direction S which preferably lies in the plane P1 and more preferably is parallel to the length of the banknote 2. The direction shown at T is transverse, and particularly perpendicular, to the scanning direction S and also lies within the plane P1 of the banknote 2. The direction which is normal to the banknote 2 is shown at N.

The apparatus includes a first optical device 3 including a light transmitter 4 which is arranged to transmit light to the banknote 2 along a path which is parallel to a plane P2. The plane P2 contains the transverse direction T and is located at an angle, for example about 20°, to the normal direction N. The device 3 also includes two light receivers 6, 7 positioned in close proximity to, and on respective sides of, the transmitter 4 and displaced from each other in the transverse direction T.

Any light which is reflected from the banknote back in the direction which is substantially reverse to the direction of the transmitted light will be received by the receivers 6, 7 located near the transmitter 4. This will be diffusely reflected light. Any directly (i.e. specularly) reflected light will travel in a direction 8 away from the transmitter 4 and the receivers 6, 7, and be detected by a further receiver 9.

A similar arrangement, involving a device 3′ comprising a transmitter 4′ and receivers 6′, 7′, 9′ is located diametrically opposite the device 3, on the opposite side of the path of the banknote 2, to measure the reflectance characteristics of the other side (in the drawing the underside) of the banknote. The receivers 6 and 7 are arranged to receive, in addition to light from the transmitter 4 reflected by the banknote, light from the transmitter 4′ transmitted through the banknote. Similarly, the receivers 6′, 7′ can receive light from the transmitter 4 which has been transmitted through the banknote 2. Accordingly, each of the receivers 6, 6′, 7, 7′ can be used to detect both the diffuse-reflectance and transmission characteristics of the banknote 2.

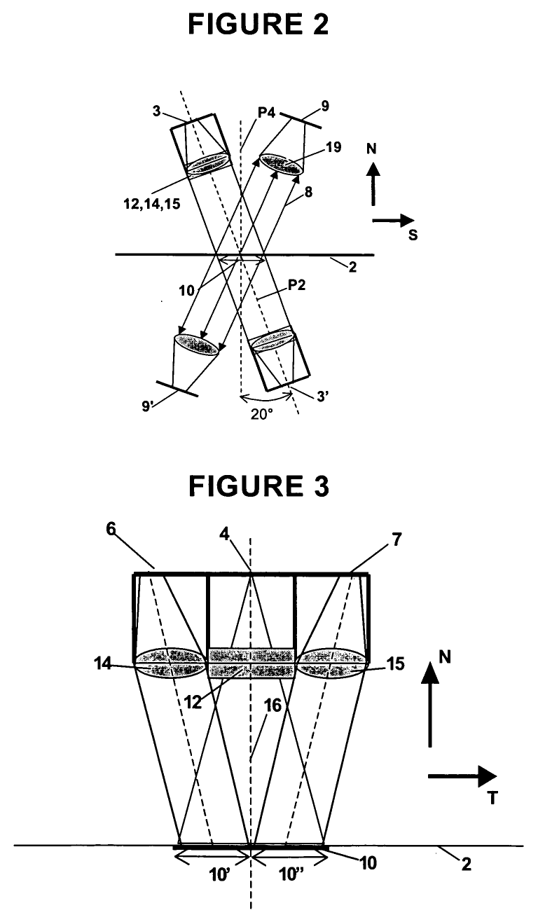

FIG. 2 is a side view of the devices 3, 3′, the plane of the drawing corresponding to a plane P3 (FIG. 1) containing both the scanning direction S and the normal N. The light from the transmitter 4 forms a beam which illuminates an area 10 of the banknote. A lens 12 (see also FIG. 3) collimates the light so that there is substantially no divergence of the beam when viewed in the plane P3. Accordingly, all the directly reflected light travelling in the direction 8 will avoid the receivers 6, 7. A focussing lens 19 focuses directly-reflected light onto the sensor 9.

In FIG. 3, the plane of the drawing corresponds to a plane P4 (FIGS. 1 and 2) containing both the transverse direction T and the normal N. It will be noted that the light beam from the transmitter 4 diverges in order to illuminate the area 10. A lens 14, having a skewed optic axis, focuses approximately half the area 10, indicated at 10′, on to the receiver 6. A lens 15, also having a skewed optic axis, focuses the other half of the area 10, indicated at 10″, on to the receiver 7. The arrangement is symmetrical about the optic axis 16 of the transmitter 4.

Accordingly, a single transmitter 4 is used to illuminate the areas sensed by two separate diffuse-reflection receivers 6, 7, and one direct-reflection receiver 9, thus reducing the number of transmitters required. Furthermore, because the light diverges in the planes P2, P4 containing the transverse direction T, but not in the plane P3 containing the scanning direction S, a relatively large area can be illuminated while still avoiding the sensing of direct reflection by the receivers 6, 7. The light from the transmitter 4 incident on the banknote and the light from the banknote to the receivers 6, 7 travel in opposite directions in substantially the same path, the small path difference being as a result of the fact that the physical sizes of the transmitter and receivers cause a small angle to be subtended between the light paths at the banknote.

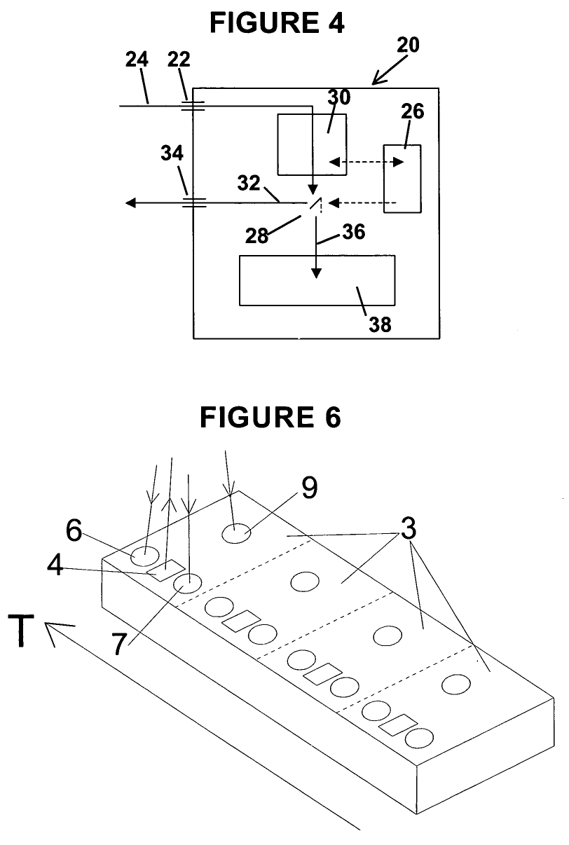

FIG. 4 illustrates a banknote validator 20 in accordance with the invention. The validator has an inlet 22 arranged to receive banknotes which travel along a path 24 to an apparatus 30 which is arranged to test the optical transmission and reflectance characteristics of the banknote. A control means 26 is arranged to send signals to and receive signals from the apparatus 30 and to use the received signals to classify the banknote, and in particular to determine its authenticity, denomination and condition. The banknote travels from the apparatus 30 to a gate 28 which is controlled by the control means 26 in dependence upon the type of banknote received as determined by the classification. The gate can direct the banknote either to a path 32 leading to an outlet 34, or to a path 36 leading to a banknote store 38.

The classification process can operate according to standard techniques, e.g. by comparing the measured data to sets of stored acceptance criteria each associated with a known denomination, except that the criteria would relate to additional measurements, particularly directly-reflected light. Accordingly, the apparatus would be sensitive to further factors, such as those mentioned above (e.g. the shininess of areas of the banknote). The classification process can be used to place banknotes into several categories; in addition to determining whether a banknote is authentic, the apparatus can also determine whether the condition of the banknote is such as to render it unsuitable for dispensing.

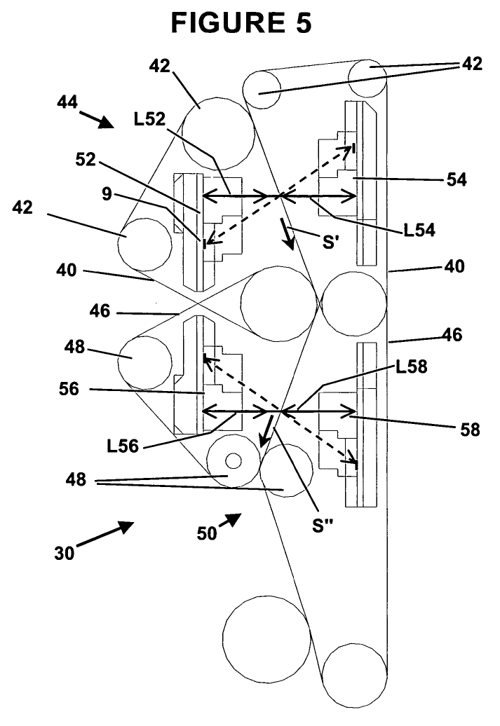

The apparatus 30 for sensing the optical characteristics of banknotes is shown in more detail in the side view of FIG. 5. Banknotes are conveyed through the apparatus by means of endless belts 40 and sets of rollers 42 at the inlet side 44 of the apparatus and endless belts 46 and sets of rollers 48 at the outlet side 50 of the apparatus. The belts 40 and rollers 42 at the inlet side 44 of the apparatus are disposed laterally between the belts 46 and rollers 48 at the outlet side 50 of the apparatus. The banknotes are conveyed along a bent scanning path, first in a scanning direction S′ in the inlet side 44 and then in a scanning direction S″ in the outlet side 50.

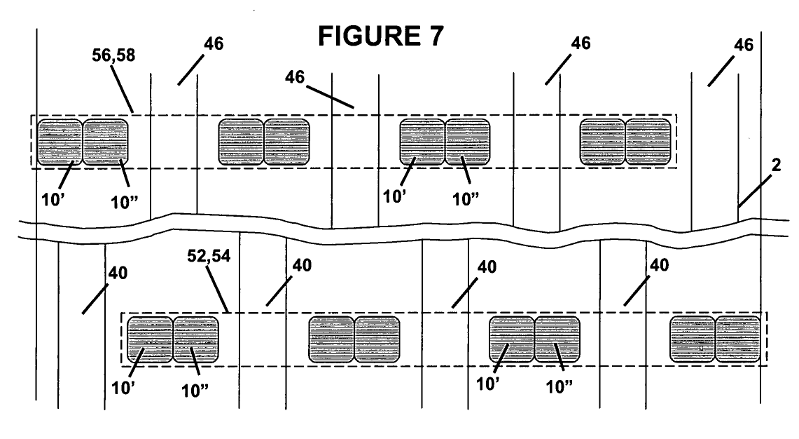

The optical devices 3 (which are identical to the devices 3′) are arranged in modules, or units. One such unit is shown schematically in FIG. 6. Each unit comprises four optical devices 3 arranged in a line extending in the transverse direction T, each device comprising a transmitter 4, a pair of diffuse-reflection receivers 6, 7 and a direct-reflection receiver 9 arranged as shown in FIGS. 2 and 3 to sense the reflectance and transmission characteristics in a pair of adjacent areas 10′, 10″ (FIG. 7) of the banknotes. Within each of the devices 3, the transmitter 4 and the receivers 6 and 7 are mounted on a common circuit board. If desired, a single circuit board can be used for all the devices 3 within a single module.

A first optical unit 52 is disposed at the left of the banknote path at the inlet side 44, and faces a second unit 54 at the right of the banknote path. The units 52 and 54 are arranged for sensing the reflectance and transmittance characteristics of the banknotes in scanned areas which extend between the inlet belts 40.

Two further units, 56 and 58, are disposed respectively at the left and right of the banknote path at the outlet side 50. These are of similar structure and orientation to the modules 52 and 54, except that they are arranged to scan the areas between the outlet belts 46. Accordingly, as indicated in the plan view of FIG. 7, the units 52, 54, 56 and 58 can scan the entire width of the banknote, each pair of units scanning areas between the areas scanned by the other pair.

It will be seen from FIG. 5 that the volume occupied by the units 52 to 58 can be relatively small, despite the fact that both transmittance and reflectance is measured right across the width the banknote. This is because (a) receivers are used for sensing both diffuse-reflectance and transmittance characteristics, (b) each receiver is mounted in close proximity to the transmitter which emits the light which the receiver uses for sensing reflectance characteristics, (c) each transmitter illuminates sufficient area for two receivers, and (d) common transmitters are used for transmittance, diffuse-reflectance and direct-reflectance measurements.

In the preferred embodiment, each transmitter comprises an LED package which includes a plurality of dies each of a respective wavelength, for example red, green, blue and infra-red.

The operation of the validator 20 of FIG. 4 is as follows. A received. banknote is delivered to the inlet side 44 of the apparatus 30. The control means 26 continuously checks the light transmitted between the optical units 52, 54 in the inlet section 44 until it detects the significant change caused by the leading edge of the banknote. Further movement of the banknote in the scanning direction is tracked using an encoder so that the subsequent transmission and reflectance measurements can be associated with respective positions on the banknote.

As the banknote continues to travel between the units 52, 54, various transmission and reflectance measurements are taken in sequence under the control of the control means 26 which activates the respective dies of different wavelengths, and enables the respective receivers, according to a stored programme. Preferably, the arrangement is such that: (a) dies of different wavelengths are not energised at the same time, (b) reflectance measurements made by each unit take place when the opposed transmitter on the other side of the banknote path is de-energised, and (c) transmission measurements made by each receiver take place when its adjacent transmitter is de-energised.

The measurements are initially carried out using the units 52, 54, but similar measurements are also carried out by the units 56, 58 when the leading edge of the banknote has reached these units, as determined by the output of the encoder.

In FIG. 5, the banknote path is bent and the angles formed by the light paths of the transmitters at the input side are opposite to the angles formed by the corresponding light paths at the output side. Thus, the transmitters of unit 52 on the left of the path at the inlet side produce light paths L52 which form an obtuse angle with respect to the direction S′ of movement of the banknote, whereas the transmitters of the left unit 56 at the outlet produce light paths L56 which form an acute angle with respect to the direction S″ of movement. Correspondingly, at the right side, the inlet unit 54 uses light paths L54 which are acute with respect to direction S′ and the outlet unit 58 uses light paths L58 which are obtuse with respect to direction S″. (The direct-reflection light paths are shown in broken lines, with one of the direct-reflection sensors being shown at 9.)

The consequence of this is that all the units are mounted parallel to each other, with the upper units 52, 56 co-planar and the lower units 54, 58 also co-planar. This provides a compact and conveniently assembled structure.

The arrangements described above all allow for particularly compact arrangements which scan substantially the entire width of the banknote over substantially its entire length. However, other arrangements are possible. For example, the scanning direction could be different; in an alternative embodiment, banknotes are scanned in the direction T shown in FIGS. 1, 3 and 5, instead of the direction S. This might be appropriate if the banknote is to be scanned only along discrete tracks extending in the scanning direction, rather than completely across the banknote. In such an arrangement, it is less advantageous to have the light diverge in the plane containing the direction T.

1. Apparatus for classifying a banknote in dependence upon, at least, the optical characteristics of the banknote, the apparatus having:
scanning means for optically scanning the document;
an optical transmitter for directing light at the scanned banknote in a first direction inclined to the normal direction of the banknote when viewed in a plane containing said normal and the scanning direction;
a first optical receiver positioned to detect light from the transmitter which has been transmitted through and/or diffusely reflected from the banknote and which travels from the banknote to the first optical receiver along a direction substantially parallel to said first direction when viewed in said plane containing said normal and the scanning direction;
a second optical receiver positioned to detect light from the transmitter which has been specularly reflected from the banknote; and
classifying means responsive to, at least, the outputs of the first and second optical receivers for determining the authenticity and/or denomination of the banknote.

2. Apparatus as claimed in claim 1, wherein the classification means is responsive to a plurality of signals representative of both the spectral characteristics of, and the specularly reflected light from, each of a plurality of respective areas of the banknote.

3. Apparatus as claimed in claim 2, wherein the respective areas are disposed in succession along the length and width of the banknote.

4. Apparatus as claimed in any preceding claim, including a common transmitter (4), a first receiver (9) for receiving light from the transmitter which has been specularly reflected by the banknote, and a second receiver (6; 7) for receiving light from the transmitter which has been diffusely reflected from the banknote.

5. Apparatus as claimed in any one of claims 1 to 3, including a common transmitter (4), a first receiver (9) for receiving light from the transmitter which has been specularly reflected by the banknote, and a second receiver (6′; 7′) for receiving light from the transmitter which has been transmitted through the banknote.

6. Apparatus as claimed in any one of claims 1 to 3, including a common transmitter (4), a first receiver (9) for receiving light from the transmitter (4) which has been specularly reflected by the banknote, a second receiver (6; 7) for receiving light from the transmitter (4) which has been diffusely reflected by the banknote, and a third receiver (6′; 7′) for receiving light from the transmitter (4) which has been transmitted through the banknote.

7. Apparatus as claimed in any one of claims 4 to 6, including a plurality of transmitters (4) disposed along a first direction for scanning respective regions of the banknote, and means for driving the banknote in a scanning direction transverse to said first direction.

8. Apparatus as claimed in claim 7, wherein, when considered in a plane which contains the scanning direction and the normal to the banknote, the light path from each transmitter to the banknote is inclined with respect to said normal.

9. Apparatus as claimed in claim 8, wherein, when considered in said plane, the detected diffusely-reflected light travels in substantially the same path, but the opposite direction, to light incident on the banknote.

10. Apparatus for classifying a banknote in dependence upon, at least, the optical characteristics of the banknote, the apparatus having classifying means responsive to light indicative of the spectral characteristics of the banknote which has been transmitted through and/or diffusely reflected from, the banknote, and further responsive to light which has been specularly reflected from the banknote.
